(19) United States
(12) Patent Application Publication
(10) Pub. No.: US 2015/0098369 A1
(43) Pub. Date: Apr. 9, 2015

(54) REFERENCE SIGNAL DESIGN FOR SPECIAL SUBFRAME CONFIGURATIONS

(71) Applicants: Xinghua Song, Beijing (CN); Christian Hoymann, Aachen (DE); Erik Eriksson, Linkoping (SE)

(72) Inventors: Xinghua Song, Beijing (CN); Christian Hoymann, Aachen (DE); Erik Eriksson, Linkoping (SE)

(73) Assignee: Optis Wireless Technology, LLC, Plano, TX (US)

(21) Appl. No.: 14/400,304

(22) PCT Filed: Sep. 13, 2012
(86) PCT No.: PCT/SE2012/050963

§ 371 Date: Nov. 10, 2014

Related U.S. Application Data
(60) Provisional application No. 61/645,691, filed on May 11, 2012.

(51) Int. Cl. H04L 5/00; H04L 27/26; H04L 5/14

(52) U.S. Cl. CPC H04L 5/0053; H04L 5/14; H04L 27/2602
USPC 370/280

(57) ABSTRACT

Example embodiments are directed towards a base station, and corresponding method therein, for transmitting reference signals in a TOD wireless communications network, if a transmission format Is a Demodulation Reference Signal (DMRS) based format, the base station may transmit, to a user equipment, reference signals according a time and frequency Orthogonal Frequency Division Multiplex: (OFDM) grid featuring a special subframe configuration with a 6;6;2 timing ratio, where a DMRS: pattern is spanned among four time and frequency OFDM symbols.

### TECHNICAL FIELD

Example embodiments presented herein are directed towards a reference signal design compatible for both LTE-TDD and TD-SCMA based systems.

### BACKGROUND

Communication devices such as user equipments (UE) are enabled to communicate wirelessly in a radio communications system, sometimes also referred to as a radio communications network, a mobile communication system, a wireless communications network, a wireless communication system, a cellular radio system or a cellular system. The communication may be performed, for example, between two user equipments, between a user equipment and a regular telephone and/or between a user equipment and a server via s Radio Access Network (RAN) and possibly one or more core networks, comprised within the wireless communications network.

User equipments are also known as, for example, mobile terminals, wireless terminals and/or mobile stations, mobile telephones, cellular telephones, or laptops with wireless capability, just to mention some examples. The user equipments in the present context may be, for example, portable, pocket-storable, hand-held, computer-comprised, or vehicle-mounted mobile devices, enabled to communicate voice and/or data, via the RAN, with another entity.

The wireless communications network covers a geographical area which is divided into cell areas, wherein each cell area being served by a network node such as a Base Station (BS), e.g. a Radio Base Station (RBS), which sometimes may be referred to as e.g. eNB, eNodeB, NodeB, B node, or Base Transceiver Station (BTS), depending on the technology and terminology used. The base stations may be of different classes such as, for example, macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several radio access and communication technologies. The base stations communicate over the radio interlace operating on radio frequencies with the user equipments within range of the base stations.

In some RANs, several base stations may be connected, for example, by landlines or microwave, to a radio network controller, for example, a Radio Network Controller (RNC) in Universal Mobile Telecommunications System (UMTS), and/or to each other. The radio network controller, also sometimes termed a Base Station Controller (BSC), for example, in a Global System for Mobile Communications system (GSM), and may supervise and coordinate various activities of the plural base stations connected thereto,

In 3rd Generation Partnership Project (3GPP) Long Term Evolution (LTE), base stations, which may be referred to as eNodeBs or eNBs, may be directly connected to one or more core networks UMTS is a third generation mobile communication system, which evolved from the GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for user equipments. The 3GPP has undertaken to evolve further the UTRAN and GSM based radio access network technologies.

Multiple antenna technique is an important technology component in modern wireless communication systems. One enabler for multi-antenna technologies is the acquisition of channel state information at the transmitter or the receiver. In general, the channel can be estimated through a predefined training sequence, which is often referred to as reference signals in the literature. The reference signals are used for data demodulation as well as channel quality measurement to support scheduling and link adaptation. For OFDM based system, a typical design of reference signal is to insert known reference symbols into the OFDM time-frequency grid. According to above principles, several downlink reference signals have been already defined in LTE and its evolutions.

An example of a downlink reference signal is a Cell-Specific Reference Signal (CRS) targeting both data demodulation and channel quality measurement in 3GPP Release 8 (e.g., for transmission modes 1-6). Another example is user equipment specific reference signals (e.g., demodulation reference signals, DMRS) targeting data demodulation. A further example is Channel Stare Information Reference Signals (CSI-RS) targeting CSI estimation (e.g., for CQI/PMI/RI/etc. reportng when needed).

### SUMMARY

A need exists to provide a reference signal design compatible with the coexistence requirement between LTE-TDD and TD-SCDMA based systems. When deploying LIE-TDD on adjacent carriers with the existing TD-SCDMA network, the TDD DL/UL configuration and the special subframe configuration needs to be synchronized such that any interference from and to the TD-SCDMA system is avoided. The reference signal design must also be suitable for channel estimation and interpolation purposes. Thus, example embodiments presented herein may be utilized for providing a reference signal design for DMRS based PDSCH transmissions, where the CRS for DwPTS may be kept to a confined area within the control region while the DMRS for DwPTS may span up to 4 OFDM symbols. Therefore, positions which were originally reserved for CRS may be occupied by the new DMRS pattern.

At least one example advantage of the example embodiments presented herein is providing flexible support of CRS and DMRS based transmissions with a predefined reference signal design. A further advantage may be that no additional high layer signaling is required for the reference signal design, according to some of the example embodiments. Furthermore, the example embodiments provide improved DMRS density thereby improving the PDSCH performance. Another example advantage may be that the example embodiments allow for the support of up to an 8 layer transmission in PDSCH for DwPTS. Furthermore, unnecessary CRS overhead In DMRS based transmissions may be avoided.

Accordingly, some of the example embodiments are directed towards a method, in a base station, for transmitting reference signals in a Time Division Duplexing (TDD) wireless communications network. The method is characterized by determining a transmission format for data transmissions to a user equipment. The method is further characterized by, if the transmission format is Demodulation Reference Signal (DMRS) based, transmitting, to the user equipment, reference signals according to a time and frequency Orthogonal Frequency Division Multiplex (OFDM) grid featuring a special subframe configuration with a 6:6:2 timing ratio, where a DMRS pattern is spanned among four time and frequency OFDM resources.

Some of the example embodiments are directed towards a base station, for transmitting reference signal in a TDD wireless communications network. The base station is characterized by processing circuitry configured to determine a transmission format for data transmissions to a user equipment. The base station is further characterized by, if the transmission format is DMRS based, radio circuitry configured to transmit, to the user equipment, reference signals according to a time and frequency OFDM grid featuring a special subframe configuration with a 6:6:2 timing ratio, where a DMRS pattern is spanned among four time and frequency OFDM resources.

Some of the example embodiments are directed towards a method, in a user equipment, for receiving reference signals in a TDD wireless communications network. The method is characterized by receiving, from a base station, reference signals in a DMRS based format according tc a time and frequency OFDM gnd featuring a special subframe configuration with s 6:6:2 timing ratio, where a DMRS pattern is spanned among four time and frequency OFDM resources.

Some example embodiments are directed towards a user equipment, for receiving reference signals in a TDD Wireless communications network. The user equipment is characterized by radio circuitry configured to receive, from a base station, reference signals in a DMRS based format according to a time and frequency OFDM grid featuring a special subframe configuration with a 6:6:2 timing ratio, where a DMRS pattern is spanned among four time and frequency OFDM resources.

### DEFINITIONS

CQI Channel Quality Indicator

CRS Common Reference Signal

CSI Channel State information

DL Downlink

DMRS Demodulation Reference Signals

DwPTS Downlink Pilot Time Slot

eNB eNodeB

GP Guard Period

LTE Long Term Evolution

MCS Modulation and Coding Scheme

OCC Orthogonal Cover Code

OFDM Orthogonal Frequency Division Multiplexing

OS OFDM Symbols

PDCCH Physical Downlink Control Channel

PDSCH Physical Downlink Shared Channel

PMI Preceding Matrix indicator

RE Resource Element

RI Rank indicator

RS Reference Signal

SCDMA Synchronous Code Division Multiple Access

TD Time Division

TDD Time Division Duplexing

UE User Equipment

UL Uplink

UpPTS Uplink Pilot Time Slot

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a schematic block diagram illustrating embodiments of a communications system;

FIG. 2 is an illustrative example of the co-existence problem between TD-SCDMA and LTE TDD based systems;

FIG. 3A is a DMRS design for existing special subframe configuration 3, 4 and 8;

FIG. 3B is a DMRS design for the additional special subframe configuration;

FIGS. 4A and 4B are a CRS and DMRS, respectively, based reference signal design for one cell specific reference signals, according to some of the example embodiments;

FIGS. 5A and 5B are a CRS and DMRS, respectively, based reference signal design for two cell specific reference signals, according to some of the example embodiments;

FIGS. 6A and 6B are a CRS and DMRS, respectively, based reference signal design for four cell specific reference signals, according to some of the example embodiments;

FIG. 7 is an example node configuration of a base station, according to some of the example embodiments;

FIG. 8 is an example node configuration of a user equipment, according to some of the example embodiments;

FIG. 9 is a flow diagram depicting example operations that may be taken by the base station of FIG. 7, according to some of the example embodiments; and

FIG. 10 is a flow diagram depicting example operations that may be taken by the user equipment of FIG. 8 according to some of the example embodiments.

### DETAILED DESCRIPTION

In the following description, for purposes of explanation and not limitation, specific details are set forth, such as particular components, elements, techniques, etc. in order to provide a thorough understanding of the example embodiments. However, it will be apparent to one skilled in the art that the example embodiments may be practiced in other manners that depart from these specific details. In other instances, detailed descriptions of well-known methods and elements are omitted so as not to obscure the description of the example embodiments. The terminology used herein is for the purpose of describing the example embodiments and is not intended to limit the embodiments presented herein.

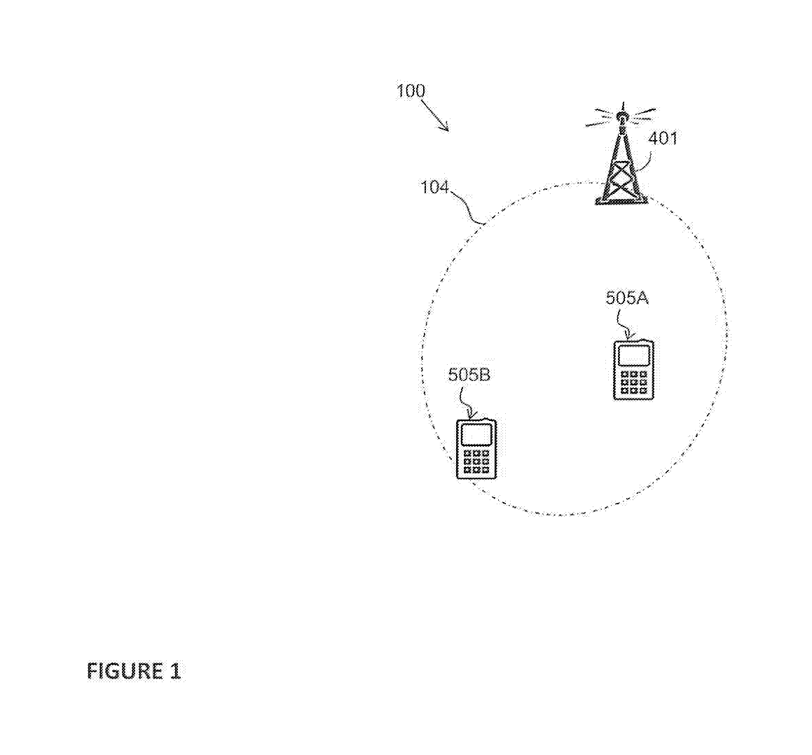

In order to provide a better explanation of the example embodiments presented herein, a problem will first be identified are discussed. FIG. 1 schematically illustrates embodiments of a radio communications system 100. The radio communication system 100 may be a 3GPP communications system or a non-3GPP communications system. The radio communications system 100 may comprises one or more of radio communications networks (not shown). Each radio communications network may be configured to support one or more Radio Access Technologies (RATs). Further, the one or more radio communications networks may be configured to support different RATs. Some examples of RATs are GSM, WCDMA, and LTE.

The radio communications system 100 comprises a radio network node such as a base station 401. The base station 401 tray be a base station such as an eNB, an eNodeB. Node B or a Home Node B, a Home eNode B, a radio network controller, a base station controller, an access point, a relay node (which may be fixed or movable), a donor node serving a relay, a GSM/EDGE radio base station, a Multi-Standard Radio (MSR) base station or any other network unit capable to serve a user equipment in the cellular communications system 100.

Further, it should be understood that the base station 401 is one example of an access node (not shown) comprised in the radio communication system 100. The base station 401 provides radio coverage over at least one geographical area 103. The radio communications system 100 further comprises any number of user equipments, tor example user equipments 505A and 505B. The user equipments 505A and 505B are located within the ceil 104 and are served by the base station 401. The user equipments 505A and 505B may transmit data over a radio interface to the base station 401 in an uplink (UL) transmission and the base station 401 transmits data to the user equipments 505A and 505B in a downlink (DL) transmission.

One important consideration for wireless communication systems, such as the system illustrated in FIG. 1, is the acquisition of channel stale information at the transmitter or receiver. In the acquisition of channel state information, reference signals are used for data demodulation as well as channel quality measurements to support the scheduling and link adaptation for various user equipments in the network. For OFDM based systems, currently there are 9 special subframe configurations defined for normal Cyclic Prefix (CP) and 7 defined for extended CP, with different length of downlink pilot time slot (DwPTS), Guard Period (GP) and uplink pilot time slots (UpPTS). For normal CP, PDSCH transmission is not supported for DwPTS spanning 3 OFDM symbols, for example, configuration 0 and configuration 5. PDSCH transmission is supported for all the remaining configurations with DwPTS spanning 9-11 OFDM symbols.

To support CRS based PDSCH transmission in DwPTS, the density of CRS in the special subframe is reduced in the time domain since the symbols comprising GP and UpPTS are punched or deleted (e.g., symbols 7-14). For example, consider the case for normal CP with CRS configured on 2 antenna ports. For configuration 4 with DwPTS spanning 12 OFDM symbols, a 4-strip CRS may be used. For configuration 1, 2, 3, 6, 7 and 8 with DwPTS spanning 9-11 OFDM symbols, a 3-strip CRS may be used.

To support DMRS based PDSCH transmission in DwPTS, two kinds of DMRS patterns have been defined, a DMRS pattern for DwPTS spanning 9-10 OFDM symbols and a DMRS pattern for DwPTS spanning 11-12 symbols. The design principle for the DMRS patterns is to spread the DMRS in the time domain as much as possible so that the performance of channel estimation could be optimized and hence the PDSCH demodulation performance.

A work item on an additional special subframe configuration for LTE-TDD has been approved in RP-120384 at RAN plenary #55, “Additional special subframe configuration for LTE TDD”, CMCC, RAN #55. The motivation comes from the coexistence requirement between LTE-TDD and TD-SCDMA. When deploying LTE-TDD on adjacent carriers with the existing TD-SCDMA network, the TDD DL/UL configuration and the special subframe configuration should be synchronized in such a manner that interference from and to a TD-SCDMA based system is avoided.

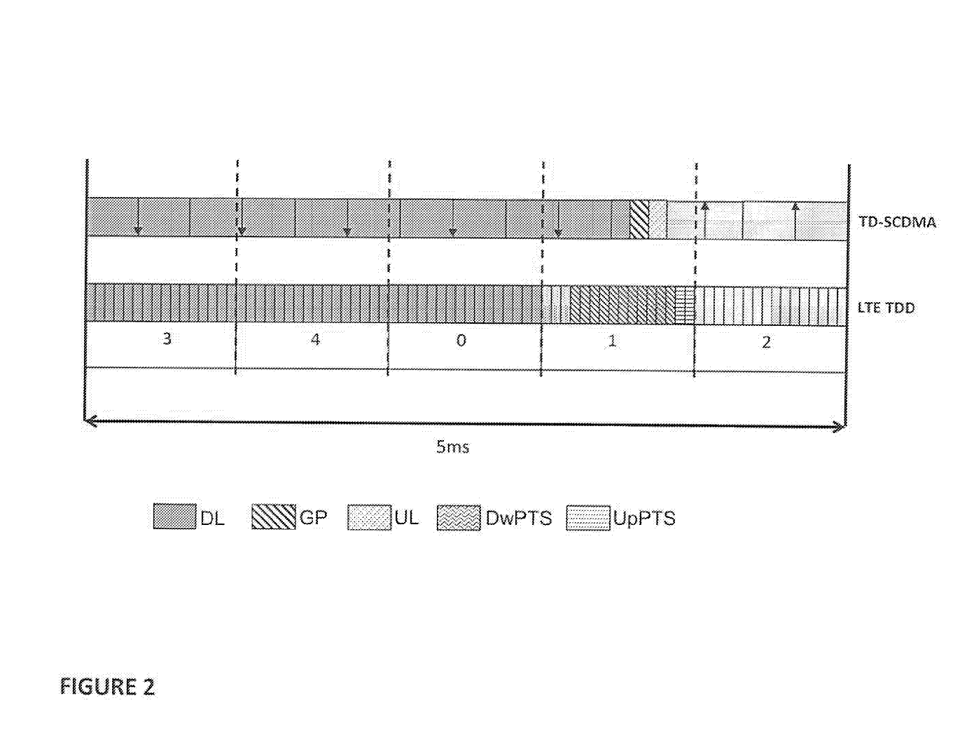

FIG. 2 provides an illustrative example of the co-existence problem between TD-SCDMA and LTE TDD based systems. FIG. 2 illustrates two subframes. The upper subframe of FIG. 2 is an example of a TD-SCDMA 5DL/2UL subframe configuration. The TD-SCDMA configuration with 5DL/2DL is widely used in current networks. The lower subframe of FIG. 2 is an example of a LIE TDD configuration 2 featuring 3 DL/1UL with a special subframe configuration 5, where DwPTS is 3 OS and UpPTS is 2OS (DwPTS:GP:UpPTS−3:9:2). It should be appreciated that no PDSCH transmission is possible in the special subframe for LTE-TDD, as illustrated in FIG. 2. As explained above, PDSCH transmission is not supported for DwPTS spanning 3 OFDM symbols, as is the case for the lower subframe of FIG. 2. By introducing additional special subframe configurations, for example, 6:6:2 for normal CP and 5:6:2 for extended CP, the coexistence requirements may still be fulfilled while at the same time downlink system efficiency is improved.

It should be appreciated that there are different ways to support PDSCH transmission in DwPTS for the additional special subframe configuration. One possible method is to only support CRS based transmission as proposed in R1-113457 at RAN1 #66bls. “On co-existence issue to UTRA LCR TDD”, CMCC. In this case, the user equipment could transmit data using CRS based transmission schemes, for example, transmit diversity, open-loop/closed-loop spatial multiplexing. An advantage of this alternative s that a new DMRS design is not needed, thus there is no standard impact introduced. However, there are some major limitations.

One example limitation is the performance for higher than rank-2 transmission is expected to be poor since the density of CRS port 2 and port 3 is very low. This leads to poor channel estimation performance especially at high speed. Another example limitation is that the spectrum efficiency is not optimized. For example, consider the case when the user equipment is in transmission mode 9 (e.g., for 3GPP Release 11 user equipments). DMRS based PDSCH transmission could be applied in normal downlink subframes while the user equipment transmits diversity in DwPTS (downlink scheduling assignment using DCI format 1A). This limits the spectrum efficiency in DwPTS.

A further example limitation is that there are potential problems in link and rank adaptation. The base station must select proper MCS levels for DwPTS and normal subframes separately. Such selection becomes difficult when the user equipment is reporting PMI/CQI/RI based on CRS or CSI-RS. For instance, without interference information at the base station. It is difficult to estimate the inter-stream interference which has a large impact in deriving MCS levels for transmission diversity from the reported CQI based on spatial multiplexing. Based on the above observations, it is better to support DMRS based PDSCH transmission in the special subframe.

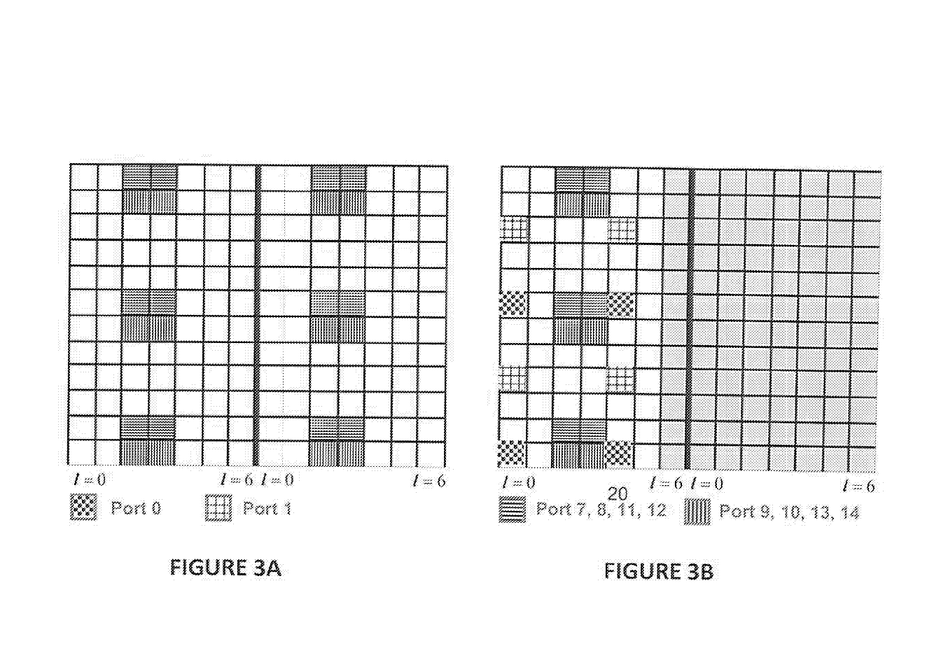

DMRS patterns have been proposed for the additional special subframe described in RP-120384. “Additional special subframe configuration for LIE TDD”, CMCC, RAN #55, as illustrated in FIGS. 3A and 3B. FIG. 3A illustrates an OFDM time and frequency grid featuring a DMRS design or pattern for existing special subframe configurations 3, 4 5 and 8. Each vertical row of the OFDM grid is a symbol Thus, the OFDM grid of FIG. 3A features 14 symbols with the leftmost symbol being symbol one and the rightmost symbol being symbol 14. In FIG. 3A, the DMRS pattern spans symbols 3, 4, 10 and 11.

FIG. 3B illustrates a DMRS design for the additional special subframe configuration. As is illustrated in FIG. 3B, for normal CP in the additional special subframe configuration, it has been proposed to reuse the current DMRS patterns for special subframe configuration 3, 4 and 8 (as illustrated in FIG. 3A) with OFDM symbols 7-14 punctured or deleted. The punctured or deleted symbols of FIG. 3B are illustrated by grey shading and the DRMS pattern is spanned along symbols 3 and 4 only. FIG. 3B also comprises a CRS pattern spanning symbols 1 and 5.

This is a simple and straightforward DMRS design. However, there are some drawbacks. One example drawback is that the performance of the channel estimation is expected to be poor since the DMRS density is low. This is due to the fact that it is not possible to do interpolation in time since there is only one group of DMRS, as shown in FIG. 3B the DMRS pattern only spans symbols 3 and 4. This is also the case for REs or CRS of symbols 1 and 5. Another example drawback is that this pattern can only support up to 4-stream transmission since the length of the orthogonal cover code (OCC) is only 2 (e.g., the number of Res in the time domain in the PDSCH region is 2).

Moreover, there are similar challenges to link/rank adaptation as it Is the case of CRS only based transmission, for example, with a different allowable number of streams between DwPTS and normal subframes. It is difficult to estimate inter-stream interference based on a CSI report with different hypothesis on the number of PDSCH transmissions. A further example drawback is that the additional overhead of CRS cannot be avoided even when a DMRS based transmission is applied. Assuming 2 CRS configured by the eNB, the CRS occupies 4 additional resource elements without providing any help to demodulation for PDSCH. Considering the limited number of REs within DwPTS, it is a waste of resources.

Thus, some of the example embodiments presented herein provide a downlink reference signal design for the additional special subframe configuration, comprising the design for cell-specific reference signals (CRS) and the design for demodulation reference signals (DMRS). In the case of CRS based PDSCH transmission, the current CRS pattern may be reused while puncturing portions of an OFDM time and frequency gird comprising GP and UpPTS. In the case of DMRS based PDSCH transmission, the CRS pattern for DwPTS may be kept to one strip of the OFDM time and frequency grid within the control region (PDCCH) while the DMRS pattern for DwPTS may span up to 4 OFDM symbols. The positions originally reserved for CRS will also be occupied by the new DMRS pattern.

According to some of the example embodiments, for CRS based PDSCH transmission, the cell-specific reference signals within GP and UpPTS may be punctured. The cell-specific reference signals in the control region (first one or two OFDM symbols) are used for PDCCH decoding and may also be used jointly with the remaining strips for PDSCH demodulation.

According to some of the example embodiments, for DMRS based PDSCH transmission, the cell-specific reference signals within GP, UpPTS and PDSCH regions are punctured. For example, there are no cell-specific reference signals in PDSCH for DwPTS. The cell-specific signals in the control region (e.g., first one or two OFDM symbols) are used for PDCCH decoding while the DMRS pattern spans 4 symbols and also occupies the positions which are originally reserved for the CRS pattern.

Whether a CRS based transmission or DMRS based transmission is utilized may be determined by the corresponding PDCCH DCI format. According to some of the example embodiments, by predefining the DMRS pattern and user equipment behavior, no additional high layer signaling may be needed to indicate the reference signals patterns.

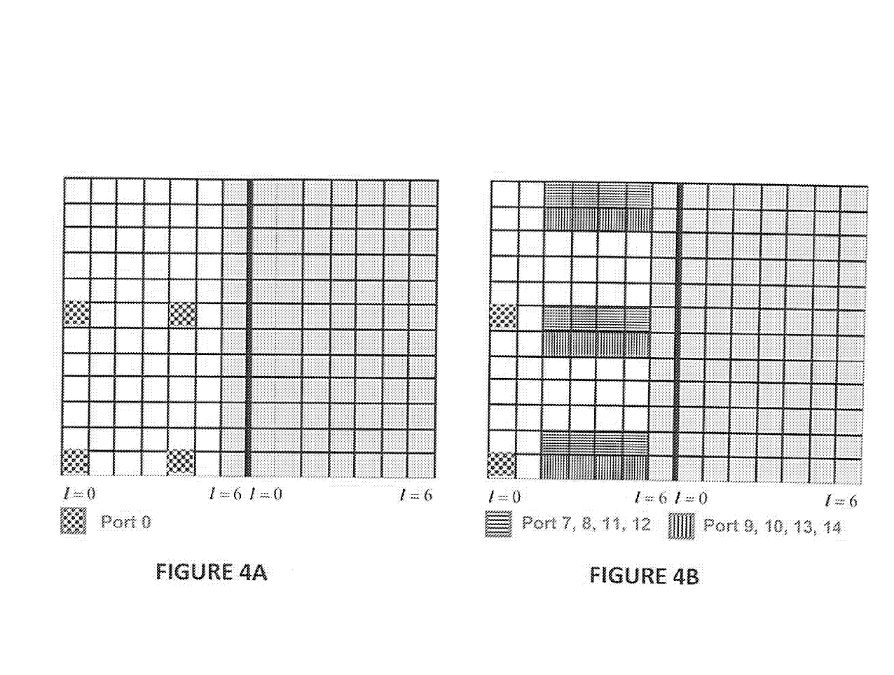

FIG. 4A provides an example of a reference signal design for the case of one cell-specific reference signals for CRS based transmission, according to some of the example embodiments. FIG. 4B illustrates an example of a reference signal design for one cell-specific reference signal and the demodulation reference signals for DMRS-based transmission. As illustrated in both FIGS. 4A and 4B, symbols 7-14 are punctured. The reference signal design for the CRS based transmission features a CRS pattern which is located in symbols 1 and 5, as illustrated in FIG. 4A. For the DMRS pattern, the same CRS pattern of FIG. 4A is utilized. However, in FIG. 4B, the CRS pattern is limited to the control region of the OFDM grid (the first two symbols), thus the CRS pattern is only comprised in symbol 1. The DMRS pattern of FIG. 4B is spanned along the last four symbols of the OFDM grid, symbols 3-6.

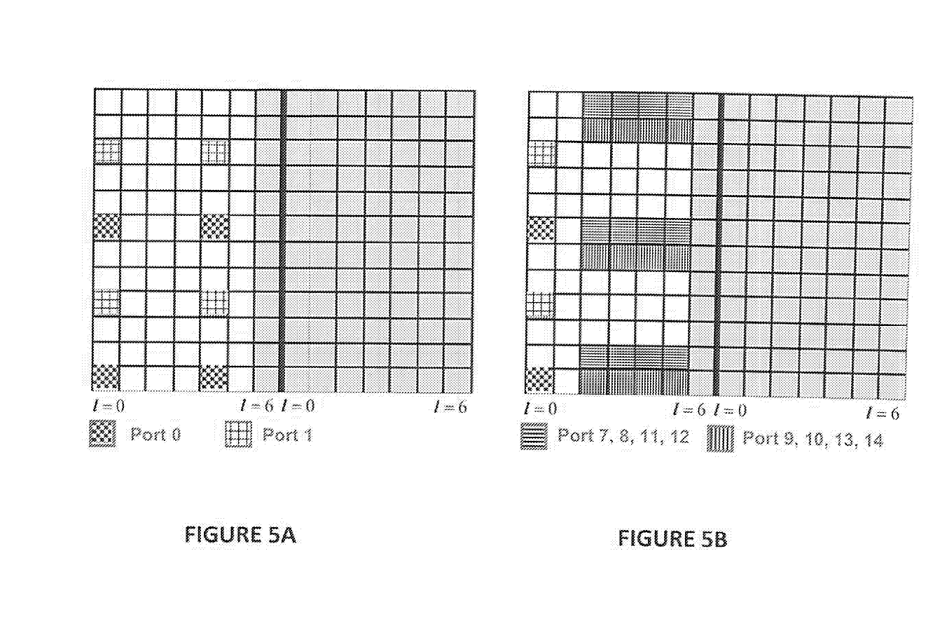

FIG. 5A provides an example of a reference signal design for the case of two cell-specific reference signals for CRS based transmission, according to some of the example embodiments. FIG. 5B illustrates an example of a reference signal design for the case of two cell-specific reference signals for cell-specific reference signal and the demodulation reference signals for DMRS-based transmission. Similarly to FIGS. 4A and 4B. FIGS. 5A and 5B feature symbols 7-14 which are punctured. The reference signal design for the CRS based transmission features a CRS pattern which is located in symbols 1 and 5, as illustrated in FIG. 5A. For the DMRS pattern, the same CRS pattern of FIG. 4A is utilized. However, in FIG. 5B, the CRS pattern is limited to the control region of the OFDM grid (the first two symbols), thus the CRS pattern is only comprised in symbol 1. The DMRS pattern of FIG. 4B is spanned along the last four symbols of the OFDM grid, symbols 3-6.

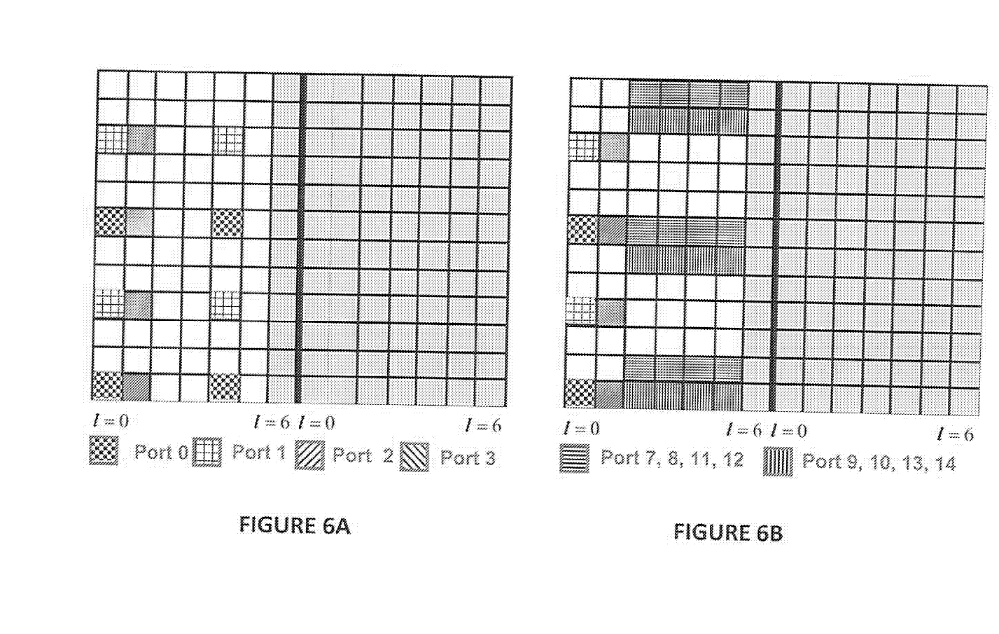

FIG. 6A provides an example of a reference signal design for the case of three cell-specific reference signals for CRS based transmission, according to some of the example embodiments. FIG. 6B illustrates an example of a reference signal design for the case of three cell-specific reference signals for cell-specific reference signal and the demodulation reference signals for DMRS-based transmission. As illustrated in both FIGS. 6A and 6B, symbols 7-14 are punctured. The reference signal design for the CRS based transmission features a CRS pattern which is located in symbols 1, 2 and 5, as illustrated in FIG. 6A. For the DMRS pattern, the same CRS pattern of FIG. 6A is utilized. However, in FIG. 4B, the CRS pattern is limited to the control region of the OFDM grid (the first two symbols), thus the CRS pattern is only composed in symbols 1 and 2. The DMRS pattern of FIG. 6B is spanned along the last four symbols of the OFDM grid, symbols 3-8.

FIGS. 4B, 5B, and 6B all illustrate two DMRS pairs (e.g., two sets of two DMRS Res) on the same frequency or horizontal fine of the OFDM grid. Thus, frequency shifting may be applied between the pairs, in some of the example embodiments, DMRS based transmissions data may be sent on symbols occupier, by CRS for CRS based transmissions.

FIGS. 4A, 4B, 5A, 5B, 6A and 6B illustrate the case of normal CP. However, it should be appreciated that the example embodiments may be equally applicable for the case of extended CP, where 5 symbols are available for DwPTS. The last symbol of the DwPTS for normal CP may be punctured to apply the design for the extended CP.

According to some of the example embodiments, two or more user equipments that are using different RS types for PDSCH demodulation may be scheduled in the same subframe where different behaviors may be foreseen. This is regarded as an error case and may be avoided by base station implementation. Hence the base station scheduler avoids scheduling user equipments using different RS types for PDSCH demodulation. This behavior may be modified in a way that DMRS is punctured on REs that are used for CRS and CRS is transmitted on the REs. A user equipment assumes that CRS is present on all PRBs of the L1/L2 control region, for example, as illustrated in OFDM symbols 1 and 2. In symbols outside that region, CRS is only present on those PRBs that have been allocated for PDSCH transmission to that particular user equipment

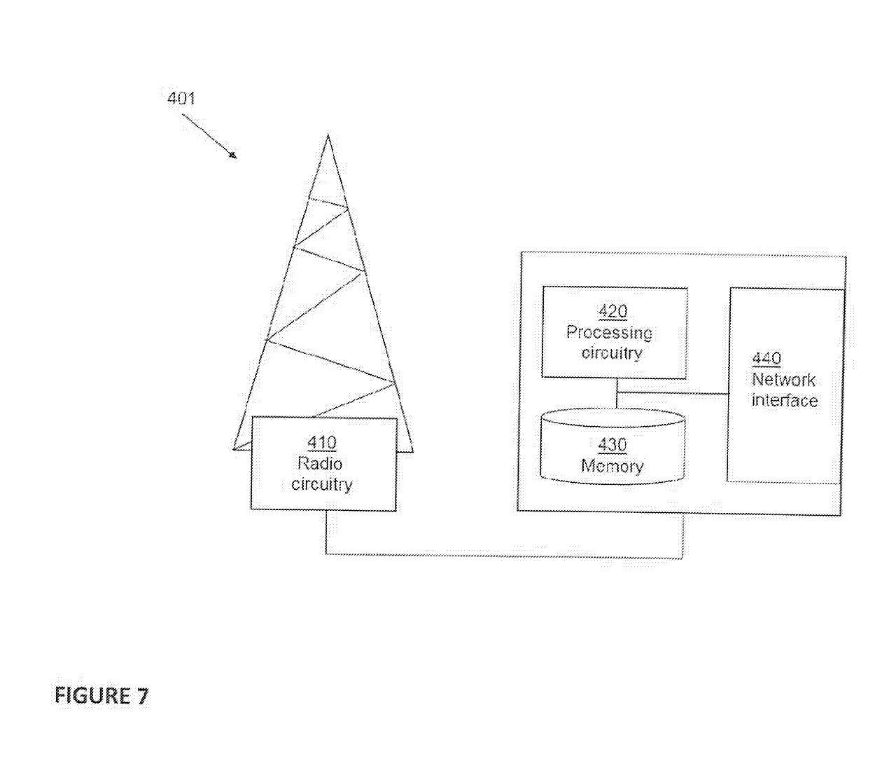

FIG. 7 illustrates an example of base station 401 which may incorporate some of the example embodiments discussed above. As shown in FIG. 7 the base station 401 may comprise a radio circuitry 410 configured to receive and transmit any form of communications or control signals within a network. It should be appreciated that the radio circuitry 410 may be comprised as any number of transceiving, receiving, and/or transmitting units or circuitry. It should further be appreciated that the radio circuitry 410 may be in the form of any input/output communications port known in the art. The radio circuitry 410 may comprise RF circuitry and baseband processing circuitry (not shown).

The base station 401 may further comprise at least one memory unit or circuitry 430 that may be in communication with the radio circuitry 410. The memory 430 may be configured to store received or transmitted data and/or executable program instructions. The memory 430 may also be configured to store any form of beamforming information, reference signals, and/or feedback data or information. The memory 430 may be any suitable type of computer readable memory and may be of volatile and/or non-volatile type.

The base station 401 may further comprises a network interface 440 and processing circuitry 420 which may be configured to generate and provide instructions or control signals related to reference signals. The processing circuitry 420 may also be configured to provide configuration instructions to the user equipment. The processing circuitry 420 may be any suitable type of computation unit, e.g. a microprocessor, digital signal processor (DSP), field programmable gate array (FPGA), or application specific integrated circuit (ASIC) or any other form of circuitry. It should be appreciated that the processing circuitry need not be provided as a single unit but may be provided as any number of units or circuitry.

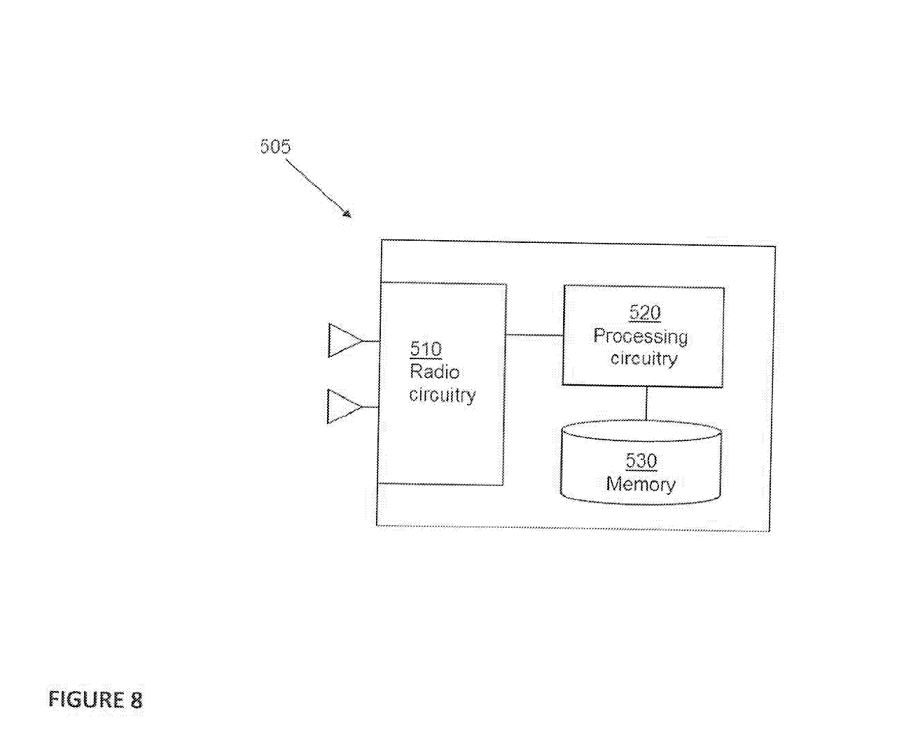

FIG. 8 illustrates an example of a user equipment 505 which may incorporate some of the example embodiments discussed above. As shown in FIG. 8, the user equipment 505 may comprise radio circuitry 510 configured to receive and transmit any form of communications or control signals within a network. It should be appreciated that the radio circuitry 510 may be comprised as any number of transceiving, receiving, and/or transmitting units or circuitry. It should further be appreciated that the radio circuitry 510 may be in the form of any input/output communications port known in the art. The radio circuitry 510 may comprise RF circuitry and baseband processing circuitry (not shown).

The user equipment 505 may further comprise at least one memory unit or circuitry 530 that may be in communication with the radio circuitry 510. The memory 530 may be configured to store received or transmitted data and/or executable program instructions. The memory 530 may also be configured to store any form of beamformlng information, reference signals, and/or feedback data or information. The memory 530 may be any suitable type of computer readable memory and may be of volatile and/or non-volatile type.

The user equipment 505 may further comprise further processing circuitry 520 which may be configured to analyse reference signals provided by the base station. The processing circuitry 520 may be any suitable type of computation unit, e.g. a microprocessor, digital signal processor (DSP), field programmable gate array (FPGA), or application specific integrated circuit (ASIC) or any other form of circuitry. It should be appreciated that the processing circuitry need not be provided as a single unit but may be provided as any number of units or circuitry.

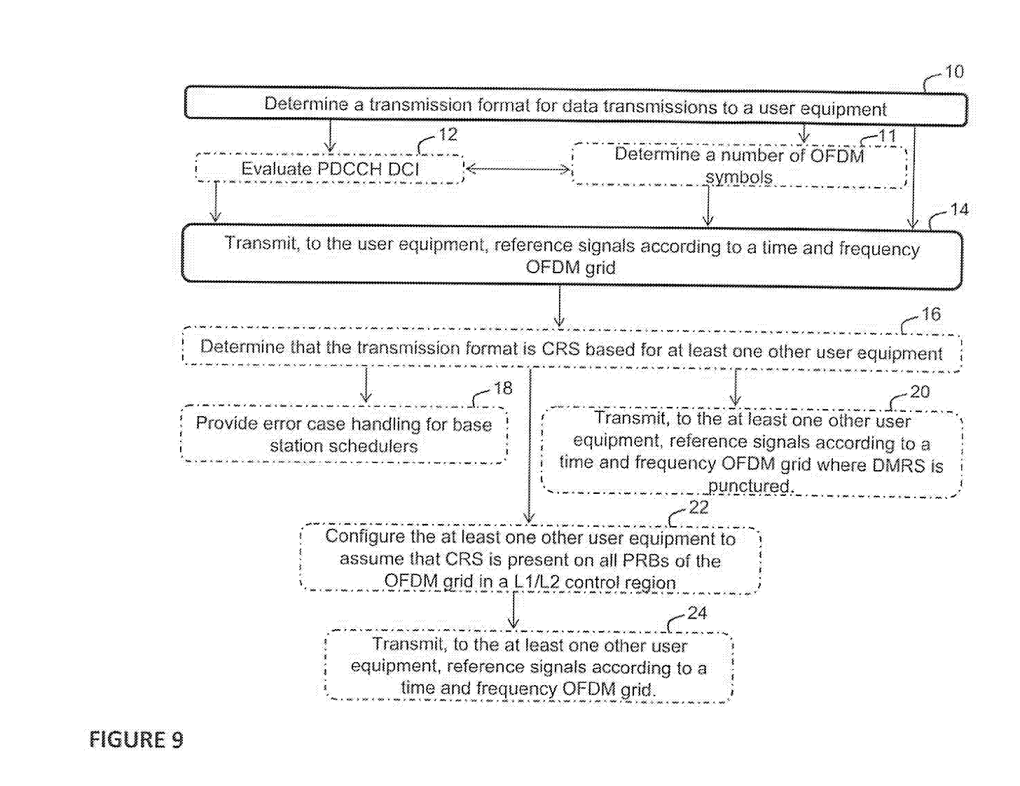

FIG. 9 is a flow diagram depicting example operations which may be taken by the base station of FIG. 7, during the generation and providing of instructions or control signals related to reference signals, according to some of the example embodiments. It should be appreciated that FIG. 9 comprises some operations which are illustrated with a solid border and some operations which are illustrated with a dashed border. The operations which are comprised in a solid border are operations which are comprised in the broadest example embodiment. The operations which are comprised in a dashed border are example embodiments which may be comprised in, or a part of, or are further operations which may be taken in addition to the operations of the border example embodiments. It should be appreciated that these operations need not be performed in order. Furthermore, it should be appreciated that not all of the operations need to be performed. The example operations may be performed in any order and in any combination.

Operation 10

The base station 401 is configured to determine 10 a transmission format for data transmissions to a user equipment 505. The processing circuitry 420 is configured to determine the transmission format. According to some of the example embodiments, the transmission format may be a DMRS based and/or CRS based.

Example Operation 11

According to some of the example embodiments, the determining 10 further comprises determining 11 a number of downlink symbols is at most six The processing circuitry may determine the number of downlink symbols is at most six. According to some of the example embodiments, the DMRS pattern may be spanned among a last four of time and frequency OFDM resources. As shown in FIGS. 4A-B through 6A-B, the number of symbols utilized for the reference signal is 6 (e.g., symbols 1-6). However A should be appreciated that this is merely an example and any number of reference symbols may be utilized. Furthermore, it should be appreciated that FIGS. 4B-6B illustrate the DMRS pattern being spanned among the last four time and frequency resources, namely symbols 3-6 in the illustrative examples.

According to some of the example embodiments, if the transmission format is also CRS based, the OFDM grid may further comprise a punctured CRS pattern located in at least one designated time and frequency OFDM resource. According to some of the example embodiments, the at least one designated time and frequency OFDM resource may be a first two or first one of a time and frequency OFDM resource. According to some of the example embodiments, the punctured CRS pattern is located within a guard period, an uplink pilot time slot, and/or a physical downlink shared channel region. For example as illustrated in FIGS. 4B-6B, the CRS pattern is located only within the first two symbols.

Example Operation 12

According to some of the example embodiments, the determining 10 may further comprise evaluating 12 physical downlink control channel downlink control information. The processing circuitry 420 may be configured to evaluate the physical downlink control channel downlink control information.

Operation 14

The base station 401 is further configured to transmit 14, to the user equipment 505, reference signals according to a time and frequency OFDM grid featuring a special subframe configuration with a 6:6:2 timing ratio. The ratio is represented as DwPTS:GP:UpPTS. The DMRS pattern is spanned among four time and frequency OFDM resources. The transmission occurs if the determined format (e.g., operation 10) is a DMRS based format. The processing circuitry 420 is configured to transmit, to the user equipment 505, reference signals according to a time and frequency OFDM grid featuring a special subframe configuration with a 6:6:2 timing radio. According to some of the example embodiments, the transmitting 14 may be performed if it is determined that the number of downlink symbols is at most six.

Example Operation 15

According to some of the example embodiments, the base station 401 may be further configured to determine 16 that the transmission format is CRS based for at least one other user equipment. The processing circuitry 420 may be configured to determine the format is CRS based for at least one other user equipment.

Example Operation 18

According to some of the example embodiments, upon the determining 16, the base station 401 may be further configured to provide 18 error case handling for base station schedulers, such that user equipments with different reference signal types for physical downlink shared channel demodulation are scheduled at different time intervals. The processing circuitry 420 may be configured to provide the error case handling

Example Operation 20

According to some of the example embodiments, upon the providing 18, the base station 401 may be further configured to transmit 20, to at least one other user equipment reference signals according to a lime and frequency OFDM grid, where the DMRS pattern is punctured on resource elements that are intended to be used for a CRS pattern. Such resource elements may comprise the CRS pattern. The radio circuitry 410 may be configured to transmit, to the at least one other user equipment, the reference signals according to the time and frequency OFDM grid. Thus, the error case handling may comprise and the transmission of example operations 18 and 20 may be used to reduce interference between user equipments.

Example Operation 22

According to some of the example embodiments, the providing 18 may further comprise configuring 22 the at least one other user equipment to assume that a CRS pattern is present on all physical resource blocks of the OFDM grid in a L1/L2 control region. The processing circuitry 420 may configure the at least one other user equipment to assume that a CRS pattern is present on all physical resource blocks of the OFDM grid in the L1/L2 control region.

Example Operation 24

According to some of the example embodiments, the providing 18 and configuring 22 may further comprising transmitting 24, to the at least one other user equipment, reference signals according to a time and frequency OFDM grid. The OFDM grid may comprise a CRS pattern outside of the L1/L2 control region which is only located on physical resource blocks allocated for physical downlink shared control channel transmission for the at least one other use equipment. The radio circuitry 410 is configured to transmit, to the at least one other user equipment, the reference signals according to a time and frequency OFDM grid.

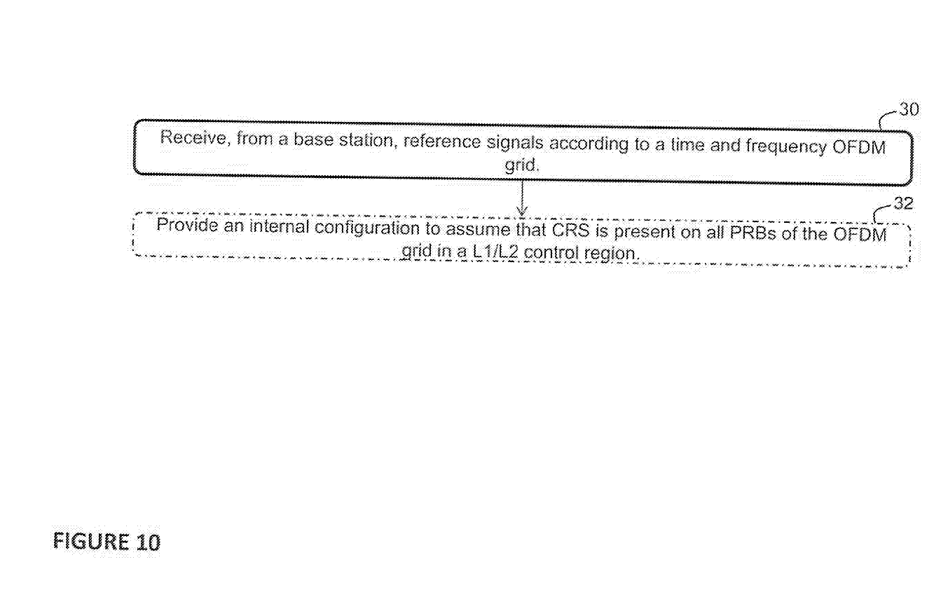

FIG. 10 is a flow diagram depicting example operations which may be taken by the base station of FIG. 8, during the analysis reference signals provided by the base station, according to some of the example embodiments.

It should be appreciated that FIG. 10 comprises some operations which are illustrated with a darker border and some operations which are illustrated with a lighter border. The operations which are comprised in a darker border are operations which are comprised in the broadest example embodiment. The operations which are comprised in a lighter border are example embodiments which may be comprised in, or a part of, or are further operations which may be taken in addition to the operations of the border example embodiments. It should be appreciated that these operations need not be performed in order. Furthermore, it should be appreciated that not all of the operations need to be performed. The example operations may be performed in any order and in any combination.

Operation 30

The user equipment 505 is configured to receive 30, from a base station 401, reference signals in a DMRS format according to a time and frequency OFDM grid featuring a special subframe configuration with a 6:6:2 timing ratio. The ratio is represented as DwPTS:GP:UpPTS. The DMRS pattern is spanned among four time and frequency OFDM resources. The radio circuitry 510 is configured to receive, from the base station 401, the reference signals in the DMRS format according to a time and frequency OFDM grid featuring a special subframe configuration with a 6:6:2 timing ratio.

According to some of the example embodiments, the number of downlink subframes may be at most six. According to some of the example embodiments, the DMRS pattern may be spanned among a last four of time and frequency OFDM resources.

According to some of the example embodiments, if the transmission format is also a CRS based format, the OFDM grid may further comprise a punctured CRS pattern located in at least one designated time and frequency OFDM resource. According to some of the example embodiments, the at least one designated time and frequency resource may be a first two of a first one of time and frequency OFDM resources. According to some of the example embodiments, the punctured CRS pattern is located within a guard period, an uplink pilot time slot, and/or a physical downlink shared channel region. For example as illustrated in FIGS. 4B-6B, the CPS pattern is located only within the first two symbols. According to some of the example embodiments, the user equipment 505 may be configured for CRS based transmission, for example, via instructions or control signals provided by the base station 401.

According to some of the example embodiments, the DMRS pattern may be punctured on resource elements that are intended to be used for a CRS pattern. The resource elements may comprise the CRS pattern in the time and frequency OFDM grid.

Example Operation 32

According to some of the example embodiments, the user equipment 505 is further configured to provide 32 an internal configuration to assume that CRS is present on all physical resource blocks of the OFDM grid in a L1/L2 control region. The time and frequency OFDM grid may comprise CRS outside of the L1/L2 control region which is only located on physical resource blocks allocated for physical downlink shaded control channel transmission. The processing circuitry 520 may be configured to provide the internal configuration to assume that the CRS is present on all physical resource blocks of the OFDM grid in the L1/L2 control region. Such providing may be implemented, for example, via instructions or control signals provided by the base station 401.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

Also note that terminology such as user equipment should be considered as non-limiting. A device or user equipment as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver, a personal communications system (PCS) user equipment that may combine a cellular radiotelephone with data processing; a personal digital assistant (PDA) that can include a radiotelephone or wireless communication system; a laptop; a camera (e.g., video and/or still image camera) having communication ability, and any other computation or communication device capable of transceiving, such as a personal computer, a home entertainment system, a television, etc. It should be appreciated that the term user equipment may also comprise any number of connected devices.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for Implementing the functions described in such steps or processes.

In the drawings and specification, there have been disclosed exemplary embodiments. However, many variations and modifications can be made to these embodiments. Accordingly although specific terms are employed, they are used in a generic and descriptive sense only and not for purposes of limitation, the scope of the embodiments being defined by the following claims.

1. A method, in a base station, for transmitting reference signals in a Time Division Duplexing, TDD, wireless communications network, the method comprising the steps of:
determining a transmission format for data transmissions to a user equipment
if the transmission format is Demodulation Reference Signal, DMRS, based, transmitting, to the user equipment, reference signals according to a time and frequency Orthogonal Frequency Division Multiplex, OFDM, grid featuring a special subframe configuration of 6:6:2, where a DMRS pattern is spanned among four consecutive OFDM symbols.

2. The method of claim 1, wherein the determining further comprises determining a number of downlink symbols, and the transmitting is performed if the number of downlink symbols is at most six.

3. The method of claim 1, wherein the DMRS pattern is spanned among a last four of time and frequency OFDM resources.

4. The method of claim 1, wherein if the transmission format is also Common Reference Signal, CRS, based, the OFDM grid further comprises a punctured CRS pattern located in at least one designated time and frequency OFDM resource.

5. The method of claim 4, wherein the at least one designated time and frequency resource is a first two or first one of time and frequency OFDM resource(s).

6. The method of claim 4, wherein the punctured CRS pattern is located within a guard period, an uplink pilot time slot, and/or a physical downlink shared channel region.

7. The method of claim 1, further comprising determining that the transmission format is CRS based for at least one other user equipment.

8. The method of claim 7, further comprising providing error case handling, for base station schedulers, such that user equipments with different reference signal types for physical downlink shared channel demodulation are scheduled at different time intervals.

9. The method of claim 8, further comprising transmitting, to the at least one other user equipment, reference signals according to a time and frequency Orthogonal Frequency Division Multiplex, OFDM, grid where the DMRS pattern is punctured on resource elements that are intended to be used for a CRS pattern, wherein said resource elements comprises the CRS pattern.

10. The method of claim 7, further comprising:
configuring the at least one other user equipment to assume that a CRS pattern is present on all physical resource blocks of the OFDM grid in a L1/L2 control region; and
transmitting, to the at least one other user equipment, reference signals according to a time and frequency Orthogonal Frequency Division Multiplex, OFDM, grid where a CRS pattern outside of the L1/L2 control region is only located on physical resource blocks allocated for physical downlink shared control channel transmission for the at least one other user equipment.

11. A base station, for transmitting reference signal in a Time Division Duplexing, TDD, wireless communications network, the base station comprising:
processing circuitry configured to determine a transmission format for data transmissions to a user equipment, wherein
if the transmission format is Demodulation Reference Signal, DMRS, based, radio circuitry configured to transmit, to the user equipment, reference signals according to a time and frequency Orthogonal Frequency Division Multiplex, OFDM, grid featuring a special subframe configuration of 6:6:2, where a DMRS pattern is spanned among four consecutive time and frequency OFDM symbols resources.

12. The base station of claim 11, wherein the processing circuitry is further configured to determine a number of downlink symbols, and the radio circuitry is configured to transmit the reference signals if the number of downlink symbols is at most six.

13. The base station of claim 11, wherein the DMRS pattern is spanned among a last four of time and frequency OFDM resources.

14. The base station of claim 1, wherein if the transmission format is also Common Reference Signal, CRS, based, the OFDM grid further comprises a punctured CRS pattern located in at least one designated time and frequency OFDM resource.

15. The base station of claim 14, wherein the at least one designated time and frequency resource is a first two or first one of time and frequency OFDM resource(s).

16. The base station of claim 14, wherein the punctured CRS pattern is located within a guard period, an uplink pilot time slot, and/or a physical downlink shared channel region.

17. The base station of claim 11, wherein the processing circuitry is further configured to determine that the transmission format is CRS based for at least one other user equipment.

18. The base station of claim 17, wherein the processing circuitry is further configured to provide error case handling, for base station schedulers, such that user equipments with different reference signal types for physical downlink shared channel demodulation are scheduled at different time intervals.

19. The base station of claim 17, wherein the radio circuitry is further configured to transmit, to the at least one other user equipment, reference signals according to a time and frequency Orthogonal Frequency Division Multiplex, OFDM, grid where the DMRS pattern is punctured on resource elements that are intended to be used for a CRS pattern, wherein said resource elements comprises the CRS pattern.

20. The base station of claim 17, wherein the processing circuitry is further configured to configure the at least one other user equipment to assume that a CRS pattern is present on all physical resource blocks of the OFDM grid in a L1/L2 control region, and the radio circuitry is further configured to transmit, to the at least one other user equipment, reference signals according to a time and frequency Orthogonal Frequency Division Multiplex, OFDM, grid where a CRS pattern outside of the L1/L2 control region is only located on physical resource blocks allocated for physical downlink shared control channel transmission for the at least one other user equipment.

21. A method, in a user equipment, for receiving reference signals in a Time Division Duplexing, TDD, wireless communications network, the method comprising the step of:
receiving, from a base station, reference signals in a Demodulation Reference Signal, DMRS, based format according to a time and frequency Orthogonal Frequency Division Multiplex, OFDM, grid featuring a special subframe configuration of 6:6:2, where a DMRS pattern is spanned among four consecutive OFDM symbols.

22. The method of claim 21, wherein a number of downlink subframes is at most six of the reference signal.

23. The method of claim 21, wherein the DMRS pattern is spanned among a last four of time and frequency OFDM resources.

24. The method of claim 21, wherein if the transmission format is also Common Reference Signal, CRS, based, the OFDM grid further comprises a punctured CRS pattern located in at least one designated time and frequency OFDM resource.

25. The method of claim 24, wherein the at least one designated time and frequency resource is a first two or first one of time and frequency OFDM resource(s).

26. The method of claim 24, wherein the punctured CRS pattern is located within a guard period, an uplink pilot time slot, and/or a physical downlink shared channel region.

27. The method of claim 26, wherein the DMRS pattern is punctured on resource elements that are intended to be used for a CRS pattern, and said resource elements comprises the CRS pattern in the time and frequency OFDM grid.

28. The method of claim 26, further comprising providing an internal configuration to assume that CRS is present on all physical resource blocks of the OFDM grid in a L1/L2 control region, and wherein the time and frequency Orthogonal Frequency Division Multiplex, OFDM, grid comprises CRS outside of the L1/L2 control region which is only located on physical resource blocks allocated for physical downlink shared control channel transmission.

29. A user equipment, for receiving reference signals in a Time Division Duplexing, TDD, wireless communications network, the user equipment comprising:
radio circuitry configured to receive, from a base station, reference signals in a Demodulation Reference Signal, DMRS, based format according to a time and frequency Orthogonal Frequency Division Multiplex, OFDM, grid featuring a special subframe configuration of 6:6:2, where a DMRS pattern is spanned among four consecutive OFDM symbols.

30. The user equipment of claim 29, wherein a number of downlink subframes is at most six of the reference signal.

31. The user equipment of claim 29, wherein the DMRS pattern is spanned among a last four of time and frequency OFDM resources.

32. The user equipment of claim 29, wherein if the transmission format is also Common Reference Signal, CRS, based, the OFDM grid further comprises a punctured CRS pattern is located in at least one designated time and frequency OFDM resource.

33. The user equipment of claim 32, wherein the at least one designated time and frequency resource is a first two or a first one of time and frequency OFDM resource(s).

34. The user equipment of claim 32, wherein the punctured CRS pattern is located within a guard period, an uplink pilot time slot, and/or a physical downlink shared channel region.

35. The user equipment of claim 34, wherein the DMRS pattern is punctured on resource elements that are intended to be used for a CRS pattern, and said resource elements comprises the CRS pattern in the time and frequency OFDM grid.

36. The method of claim 35, further comprising processing circuitry configured to provide an internal configuration to assume that the CRS pattern is present on all physical resource blocks of the OFDM grid in a L1/L2 control region, and wherein the time and frequency Orthogonal Frequency Division Multiplex, OFDM, grid comprises a CRS pattern outside of the L1/L2 control region which is only located on physical resource blocks allocated for physical downlink shared control channel transmission.
